(19) United States
(12) Patent Application Publication
(10) Pub. No.: US 2017/0109720 A1
(43) Pub. Date: Apr. 20, 2017

(54) BROWSER APPLIED IN POS TERMINAL

(71) Applicant: PAX COMPUTER TECHNOLOGY (SHENZHEN) CO., LTD., Shenzhen (CN)

(72) Inventors: Renchi ZHENG, Shenzhen (CN); Lihong XIE, Shenzhen (CN); Lei HUANG, Shenzhen (CN); Langming TAN, Shenzhen (CN)

(21) Appl. No.: 15/107,068

(22) PCT Filed: Aug. 17, 2015
(86) PCT No.: PCT/CN2015/087262

§ 371 Date: Jun. 21, 2016

(30) Foreign Application Priority Data
May 27, 2015 (CN) 201510283024.7

(51) Int. Cl. G06Q 20/20; G06F 17/22; G06F 17/27

(52) U.S. Cl. CPC G06Q 20/20; G06F 17/272; G06F 17/2247; G06F 17/271

(57) ABSTRACT

An embodiment of the present invention discloses a browser applied in a POS terminal, the browser includes an extension module configured to parse a custom extended attribute; an interface rendering module configured to receive a rendering request, parse a Hypertext Markup Language HTML5 document and draw a rendering tree; a magnetic card widget module configured to obtain magnetic card information, encrypt plaintext magnetic track data corresponding to the magnetic card information and transmit encrypted data to a transaction background for business logic; a card number input widget module configured to encrypt input card number data and transmit encrypted data to the transaction background for business logic; a cipher input widget module configured to encrypt input cipher data and transmit encrypted data to the transaction background form business logic; a script module configured to parse script codes to obtain script functions, and execute script actions corresponding to the script functions; a variable engine module configured to be bound with an interface element so as to achieve synchronous update of the variable and the interface; an event distribution module configured to link the browser with an underlying module, package events of an interface of the browser, and transmit packaged events to the underlying module.

### FIELD OF THE INVENTION

The present application relates to the technical field of computers, especially to a browser applied in a POS terminal.

### BACKGROUND OF THE INVENTION

A POS (point of sale) terminal is a multi-functional terminal. When the POS is installed in a specially-engaged commercial unit or an accepting site of credit cards and connected with a computer to form a network, it can achieve automatic electronic funds transfer. The POS terminal supports functions such as consumption, pre-authorization, balance enquiry, transfer, and so on, and is secure, convenient and reliable to use.

Currently, traditional development languages such as C/C++ and JAVA are still carried on as before in the aspect of POS application development both in China and abroad; in interface development, character interface development mode is adopted mostly even after the popularization of color screens. GUI (Graphical User Interface) tools are merely utilized by a few manufacturers. These old modes are not capable of achieving good display effect on color screens.

In traditional development modes, between interface logic and business logic there is a high coupling degree, which is not conducive for not only transplantation of applications but also collaborative development.

### SUMMARY OF THE INVENTION

One embodiment of the invention provides a browser applied in a POS terminal; the browser is able to simplify interface logic and contribute to application development.

One aspect of the invention provides a browser applied in a POS terminal, including:

an extension module configured to parse a custom extended attribute;

an interface rendering module configured to receive a rendering request, parse a hypertext markup language HTML5 document, and draw a rendering tree;

a magnetic card widget module configured to obtain magnetic card information, encrypt plaintext magnetic track data corresponding to the magnetic card information, and transmit encrypted data to a transaction background for business logic;

a card number input widget module configured to encrypt input card number data and transmit encrypted data to the transaction background for business logic;

a cipher input widget module configured to encrypt input cipher data and transmit encrypted data to the transaction background form business logic;

a script module configured to parse script codes to obtain script functions, and execute script actions corresponding to the script functions;

a variable engine module configured to be bound with an interface element so as to achieve synchronous update of the variable and the interface;

an event distribution module configured to link the browser with an underlying module, package events of an interface of the browser, and transmit packaged events to the underlying module.

In combination with the first aspect of the invention, in a first embodiment of the first aspect of the invention, the interface rendering module includes specifically:

a first receiving sub-module configured to receive a rendering request;

a first parsing sub-module configured to parse the Hypertext Markup Language HTML document, and build a document object model DOM node;

a second parsing sub-module configured to parse an attribute and a layout of the document object model DOM node, and build a rendering tree;

a drawing module configured to traverse the rendering tree and draw the rendering tree in a user interface backend.

In combination with the first aspect, or the first embodiment of the first aspect of the invention, in a second embodiment of the first aspect of the invention, the script module includes specifically:

a second receiving sub-module configured to receive a script executing request;

a third parsing sub-module configured to parse the script codes into an abstract syntax tree AST;

a fourth parsing sub-module configured to lexically parse the abstract syntax tree AST, and obtain the script functions;

an executing sub-module configured to execute script actions corresponding to the script functions on the basis of the script functions.

In combination with the second embodiment of the first aspect of the invention, in a third embodiment of the first aspect of the invention, the script actions include at least one of the following seven actions: playing warning sound, rebooting, firing an event, playing an audio, copying a variable, setting a variable, and delaying.

It can be seen from above technical solutions that the embodiments of the invention possess the following advantages: the extension module is configured to parse a custom extended attribute; the interface rendering module is configured to receive a rendering request, parse a hypertext markup language HTML5 document and draw a rendering tree; the magnetic card widget module is configured to obtain magnetic card information, encrypt plaintext magnetic track data corresponding to the magnetic card information, and transmit encrypted data to a transaction background for business logic; the card number input widget module is configured to encrypt input card number data and transmit encrypted data to the transaction background for business logic; the cipher input widget module is configured to encrypt input cipher data and transmit encrypted data to the transaction background form business logic; the script module is configured to parse script codes to obtain script functions, and execute script actions corresponding to the script functions; the variable engine module is configured to be bound with an interface element so as to achieves synchronous update of the variable and the interface; the event distribution module is configured to link the browser with an underlying module, package events of the browser interface, and transmit packaged events to the underlying module. In the browser solutions provided by the embodiment of the invention, the interface logic and the business logic are separated from each other, which is helpful for the application development; furthermore, the HTML5 is added with a payment application element by the extended attribute of the HTML5, which builds a interface with affluent elements, gives better play to colored screen, and achieves what-you-see-is-what-you-get development.

### BRIEF DESCRIPTION OF THE DRAWINGS

FIG. 1 is a structural schematic view of one embodiment of a browser provided by the present invention;

FIG. 2 is a structural schematic view of another embodiment of the browser provided by the present invention; and

FIG. 3 is a structural schematic view of another embodiment of the browser provided by the present invention.

### DETAILED DESCRIPTION OF THE PREFERRED EMBODIMENT

The technical solutions of the embodiments in the invention will be described clearly and completely with reference to the figures of the embodiments of the present invention. Obviously, the embodiments described herein are merely some but not all embodiments of the present invention. Based on the embodiments of the present invention, all the other embodiments obtainable by those skilled in the art without paying any creative work are all within the protection scope of the present invention.

It should be understood that although the embodiments of the present invention may use terms “first”, “second”, and the like to describe each user or terminal, the users or terminals should not be limited by the terms. These terms are merely be used to differentiate the users or terminals from each other. For example, under the condition of no deviation from the protection scope of the present invention, the first user can also be referred to as the second user, similarly, the second user can also be referred to as the first user; likewise, the second user can also be referred to as the third user, and so on, which is not limited by the embodiments of the invention.

Please refer to FIG. 1, an embodiment of a browser provided by the present invention includes:

an extension module 101 configured to parse a custom extended attribute;

an interface rendering module 102 configured to receive a rendering request, parse a hypertext markup language HTML5 document and draw a rendering tree;

a magnetic card widget module 103 configured to obtain magnetic card information, encrypt plaintext magnetic track data corresponding to the magnetic card information and transmit encrypted data to a transaction background for business logic;

a card number input widget module 104 configured to encrypt input card number data and transmit encrypted data to the transaction background for business logic;

a cipher input widget module 105 configured to encrypt input cipher data and transmit encrypted data to the transaction background form business logic;

a script module 106 configured to parse script codes to obtain script functions, and execute script actions corresponding to the script functions;

a variable engine module 107 configured to be bound with an interface element so as to achieve synchronous update of the variable and the interface;

an event distribution module 108 configured to link the browser with an underlying module, package events of an interface of the browser, and transmit packaged events to the underlying module.

It should be noted that HTML (Hypertext Markup Language) 5 is the core language of World Wide Web and the fifth significant revision of the HTML which is an application of the standard generalized markup language; wherein the extended attribute utilizes data—as its prefix. The browser provided by the embodiment of the present invention can parse a custom extended attribute. Since the functions of the current HTML5 are already complete, at the same time, the HTML5 supports the extended attribute with the prefix data-, the HTML5 is adaptable to increase extended functions in POS solutions.

Wherein, the magnetic card widget module 103 is a magnetic card widget which meets the requirements of secure reading and data exchange; the magnetic card widget module 103 is an extended HTML5 widget configured to read card number of a magnetic stripe card in payment industry. After obtaining a plaintext card number, the magnetic card widget module 103 chooses specified P2PE (peer-to-peer encryption) encryption mode on the basis of the configuration of the card number in the white list, and converts the plaintext magnetic track data into an encrypted magnetic track data. A user code transmits the encrypted track data to the transaction background directly. The user code has no access to the plain magnetic track data.

The card number input widget module 104 is a cardholder card number input widget meeting the PCI (Payment Card Industry) DSS (Data Security Standard) 4.X standard, which is an extended HTML5 widget used for cardholder card number input in payment industry, such as a PAN (primary account number) widget.

Wherein, the cipher input widget module 105 is a cipher input widget meeting the PCI 4.X standard, which is an extended HTML5 widget used for cipher input in payment industry, such as a PIN (Personal Identification Number) widget. After the input is accomplished, the user code can obtain encrypted PIN encryption data. Wherein, the interface of the payment widgets such as the PAN, PIN, or the like requires signature verification.

It should be noted that for further simplifying embedded development, the browser supports a variable engine; at the same time, the interface element can be bound with the variable directly. Through the binding between the variable engine module 107 and the interface element, the synchronous update of the variable and the interface can be achieved. Specifically, by the delegation model, when the input widget values changes, the bound variable can change instantly; when the variable changes, the widget bound with the variable changes its displayed value correspondingly too.

It should be noted that in embedded programming, since collaboration with domain-specific hardware is required, a simplex browser may be unable to solve issues. Therefore, some logics require to be accomplished through hard-oriented languages such as C language. The function of the event distribution module 108 is to link the browser with underlying C language codes, package events of an interface of the browser, and transmit packaged events to the underlying module.

In the embodiment of the invention, the extension module 101 is configured to parse a custom extended attribute; the interface rendering module 102 is configured to receive a rendering request, parse a hypertext markup language HTML5 document and draw a rendering tree; the magnetic card widget module 103 is configured to obtain magnetic card information, encrypt plaintext magnetic track data corresponding to the magnetic card information and transmit encrypted data to a transaction background for business logic; the card number input widget module 104 is configured to encrypt input card number data and transmit encrypted data to the transaction background for business logic; the cipher input widget module 105 is configured to encrypt input cipher data and transmit encrypted data to the transaction background form business logic; the script module 106 is configured to parse script codes to obtain script functions, and execute script actions corresponding to the script functions; the variable engine module 107 is configured to be bound with an interface element so as to achieves synchronous update of the variable and the interface; the event distribution module 108 is configured to link the browser with an underlying module, package events of the browser interface, and transmit packaged events to the underlying module. In the browser solutions provided by the embodiment of the invention, the interface logic and the business logic are separated from each other, which is helpful for the application development; furthermore, the HTML5 is added with a payment application element by the extended attribute of the HTML5, which builds a interface with affluent elements, gives better play to colored screen, and achieves what-you-see-is-what-you-get development.

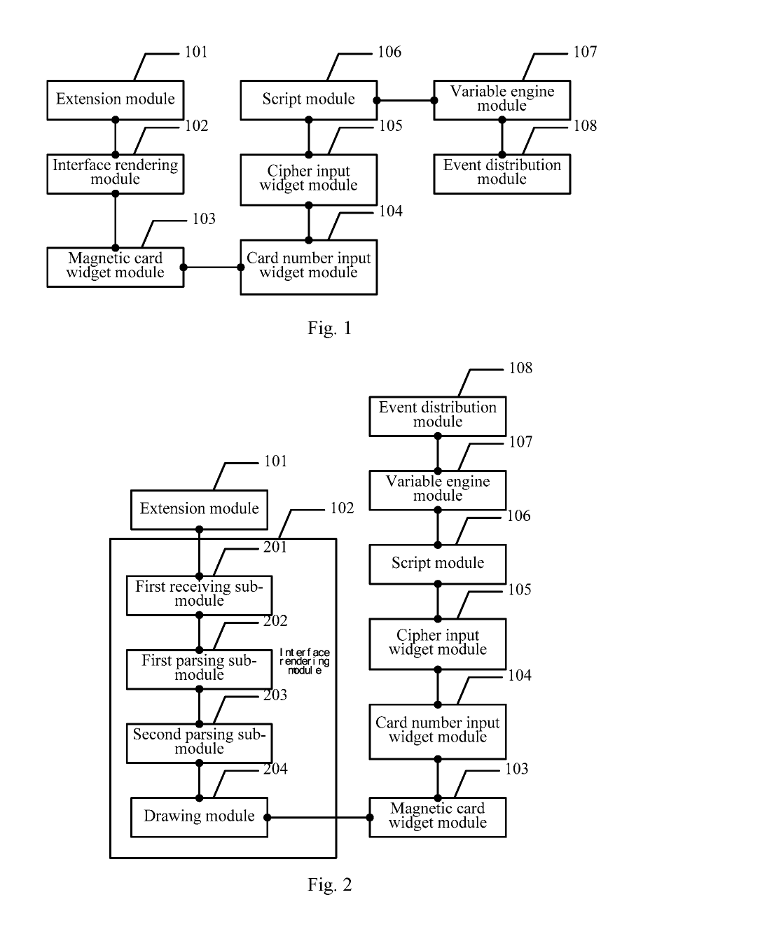

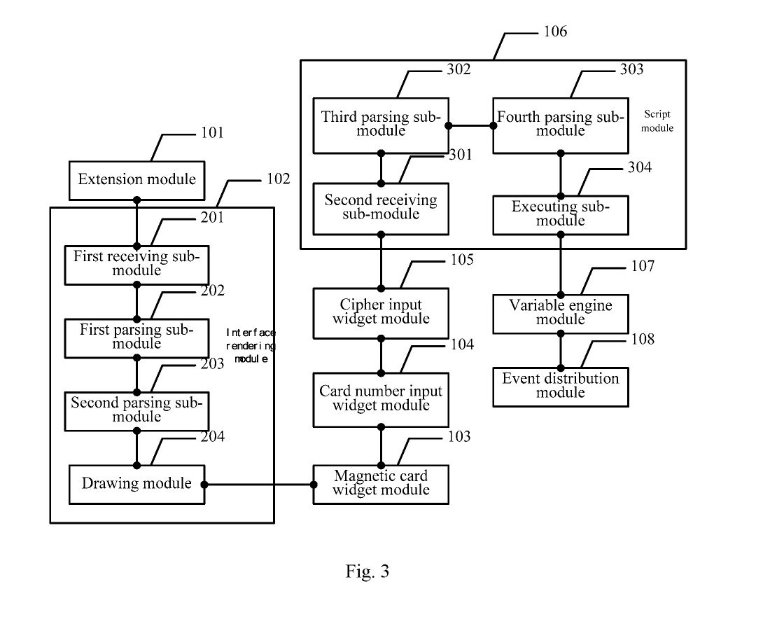

Based on the browser provided by the above mentioned embodiment, optionally, as shown in FIG. 2, the interface rendering module 102 includes specifically:

a first receiving sub-module 201 configured to receive a rendering request;

a first parsing sub-module 202 configured to parse the Hypertext Markup Language HTML5 document, and build a document object model DOM node;

a second parsing sub-module 203 configured to parse an attribute and a layout of the document object model DOM node, and build the rendering tree;

a drawing module 204 configured to traverse the rendering tree and draw the rendering tree in a user interface backend.

It should be noted that after the first receiving sub-module 201 receives a rendering request, the first parsing sub-module 202 parses the HTML5 document and converts a tag into the DOM (Document Object Model) node in a content tree. The second parsing sub-module 203 parses the attribute and the layout of each node in the tree and converts the tree into interface widgets, these widgets being configured to build another tree-a rendering tree. The drawing module 204 draws each widget in the UI (User Interface) backend by traversing the rendering tree.

Based on the browser provided by the above mentioned embodiment, optionally, as shown in FIG. 3, the script module 106 includes specifically:

a second receiving sub-module 301 configured to receive a script executing request;

a third parsing sub-module 302 configured to parse the script code into an abstract syntax tree AST;

a fourth parsing sub-module 303 configured to lexically parse the abstract syntax tree AST, and obtain the script functions;

an executing sub-module 304 configured to execute script actions corresponding to the script functions on the basis of the script functions.

It should be noted that when other events such as a button event, a timing event, and the like happen in the interface, the interface rendering module 102 invokes the script module 106 to execute the script.

After receiving the script executing request, the second receiving sub-module 301 parses the script code into the AST (Abstract Syntax Tree) by the third parsing sub-module 302; after lexically parsing the AST, the fourth parsing sub-module 303 executes corresponding actions on the basis of the parsed script functions.

Based on the browser provided by the above mentioned embodiment, optionally, the script actions include at least one of the following seven actions: playing warning sound, rebooting, firing an event, playing an audio, copying a variable, setting a variable, and delaying. For example, the supported actions are as the table below:

| Action | Script Function |
|---|---|
| Playing warning sound | Play Sound |
| Rebooting | Reboot |
| Firing an Event | FireEvent |
| Playing an Audio | PlayAudio |
| Copying a variable | CopyVariable |
| Setting a variable | SetVariable |
| Delaying | DelayMs |

It can be clearly understood for those skilled in the art that for convenience and concision of the description, the specific operation processes of the above-described systems, apparatuses and units can make reference to the correspondence processes in the above mentioned method embodiments, and are not repeated here.

It should be understood that the systems, apparatuses and methods disclosed in some embodiments provided by the present application can also be realized in other ways. For example, the described apparatus embodiments are merely schematic; for example, the division of the units is merely a division based on logic function, whereas the units can be divided in other ways in actual realization; for example, a plurality of units or components can be grouped or integrated into another system, or some features can be omitted or not executed. Furthermore, the shown or discussed mutual coupling or direct coupling or communication connection can be achieved by indirect coupling or communication connection of some interfaces, apparatuses or units in electric, mechanical or other ways.

The units described as isolated elements can be or not be separated physically; an element shown as a unit can be or not be physical unit, which means that the element can be located in one location or distributed at multiple network units. Some or all of the units can be selected according to actual needs to achieve the purpose of the schemes of the embodiments.

Furthermore, each functional unit in each embodiment of the present invention can be integrated into a processing unit, or each unit can exist in isolation, or two or more than two units can be integrated into one unit. The integrated unit can be achieved in hardware or in software function unit.

If the integrated unit is achieved in software functional unit and sold or used as an independent product, the integrated unit can be stored in a computer-readable storage medium. Based on this consideration, the substantial part, or the part that is contributed to the prior art of the technical solution of the present invention, or part or all of the technical solutions can be embodied in a software product. The computer software product is stored in a storage medium, and includes several instructions configured to enable a computer device (can be a personal computer, device, network device, and so on) to execute all or some of the steps of the method of each embodiment of the present invention. The storage medium includes a U disk, a mobile hard disk, a read-only memory (ROM, Read-Only Memory), a random access memory (RAM, Random Access Memory), a disk or a light disk, and other various mediums which can store program codes.

The above embodiments are merely intended to explain the technical solutions of the present invention, but not intended for limitation; although detail description has been made to the present invention with reference to the above embodiments, those ordinarily skilled in the art should understand that modifications to the technical solutions recited in the embodiments, or equivalent replacements to some of the technical features can still be made; these modifications and replacements do not make the substance of corresponding technical solutions depart from the spirit and scope of the technical solutions of each embodiment of the present invention.

1. A browser applied in a POS terminal, comprising:
an extension module configured to parse a custom extended attribute;
an interface rendering module configured to receive a rendering request, parse a Hypertext Markup Language HTML5 document and draw a rendering tree;
a magnetic card widget module configured to obtain magnetic card information, encrypt plaintext magnetic track data corresponding to the magnetic card information and transmit encrypted data to a transaction background for business logic;
a card number input widget module configured to encrypt input card number data and transmit encrypted data to the transaction background for business logic;
a cipher input widget module configured to encrypt input cipher data and transmit encrypted data to the transaction background form business logic;
a script module configured to parse script codes to obtain script functions, and execute script actions corresponding to the script functions;
a variable engine module configured to be bound with an interface element so as to achieve synchronous update of a variable and an interface;
an event distribution module configured to link the browser with an underlying module, package events of a browser interface, and transmit packaged events to the underlying module.

2. The browser of claim 1, wherein the interface rendering module includes specifically:
a first receiving sub-module configured to receive a rendering request;
a first parsing sub-module configured to parse the Hypertext Markup Language HTML document, and build a document object model DOM node;
a second parsing sub-module configured to parse an attribute and a layout of the document object model DOM node, and build a rendering tree;
a drawing module configured to traverse the rendering tree and draw the rendering tree in a user interface backend.

3. The browser of claim 1, wherein the script module includes specifically:
a second receiving sub-module configured to receive a script executing request;
a third parsing sub-module configured to parse the script codes into an abstract syntax tree AST;
a fourth parsing sub-module configured to lexically parse the abstract syntax tree AST, and obtain the script functions;
an executing sub-module configured to execute script script functions on the basis of the script functions actions corresponding to the

4. The browser of claim 3, wherein the script actions include at least one of the following seven actions: playing warning sound, rebooting, firing an event, playing an audio, copying a variable, setting a variable and delaying.

5. The browser of claim 2, wherein the script module includes specifically:
a second receiving sub-module configured to receive a script executing request;
a third parsing sub-module configured to parse the script codes into an abstract syntax tree AST;
a fourth parsing sub-module configured to lexically parse the abstract syntax tree AST, and obtain the script functions;
an executing sub-module configured to execute script actions corresponding to the script functions on the basis of the script functions.

6. The browser of claim 5, wherein the script actions include at least one of the following seven actions: playing warning sound, rebooting, firing an event, playing an audio, copying a variable, setting a variable and delaying.
